(19) United States
(12) Patent Application Publication
(10) Pub. No.: US 2018/0224792 A1
(43) Pub. Date: Aug. 9, 2018

(54) IMAGE FORMING APPARATUS AND CONVEYANCE SPEED CONTROL METHOD

(71) Applicant: KONICA MINOLTA, INC., Chiyoda-ku Tokyo (JP)

(72) Inventors: Yasuo SHIOKAWA, Hino-shi Tokyo (JP); Yoshiteru KAWAKAMI, Hino-shi Tokyo (JP); Takahiro OKUBO, Midori-ku Yokohama-shi Kanagawa (JP)

(21) Appl. No.: 15/889,708

(22) Filed: Feb. 6, 2018

(30) Foreign Application Priority Data
Feb. 8, 2017 (JP) 2017-021140

(51) Int. Cl. G03G 15/00

(52) U.S. Cl. CPC G03G 15/6561; B65H 7/20

(57) ABSTRACT

An image forming apparatus includes: a transferer that forms a transfer nip for transferring an image on a paper sheet; a conveyance member that is disposed upstream from the transfer nip in a conveyance direction of the paper sheet; and a hardware processor that increases a conveyance speed of the paper sheet in the conveyance member relative to a conveyance speed of the paper sheet in the transferer and controls conveyance of the paper sheet to loosen the paper sheet between the transfer nip and the conveyance member, wherein the hardware processor changes a conveyance speed of the paper sheet in the conveyance member in accordance with a conveyance length of the paper sheet in the conveyance member.

### CROSS REFERENCE TO RELATED APPLICATION

The present application claims priority under 35 U.S.C. § 119 to Japanese patent Application No. 2017-021140, filed on Feb. 8, 2017, the entire content of which is incorporated herein by reference.

### BACKGROUND

### Technological Field

The present invention relates to an image forming apparatus and a conveyance speed control method.

### Description of the Related Art

Generally, image forming apparatuses (printers, copying machines, facsimile machines, and the like) which use an electrophotographic process technology irradiate (expose) electrically-charged photoreceptor drums (image carriers) with laser light on the basis of image data to form electrostatic latent images. In each of the image forming apparatuses, toner is supplied from a developing device to a photoreceptor drum on which an electrostatic latent image is formed, and on the photoreceptor drum, the electrostatic latent image is visualized and a toner image is formed. Furthermore, the toner image directly or indirectly transferred to a paper sheet is heated, pressed, and fixed by a fusing nip, and the toner image is formed on the paper sheet.

For example, upstream from a transfer nip configured to transfer an image to a paper sheet, a pair of registration rollers is provided as a pair of conveyance rollers (e.g., see JP 2007-163854 A). When a paper sheet is held between the pair of registration rollers, the pair of registration rollers are moved in a width direction to move the paper sheet before the front end of the paper sheet enters the transfer nip, and the position of the paper sheet in the width direction is corrected.

Furthermore, commonly, a conveyance speed of a paper sheet in the pair of registration rollers is set faster than a conveyance speed of a paper sheet in the transfer nip. Such a configuration loosens a paper sheet S between the transfer nip (a portion held between rollers 423B and 424) and a pair of registration rollers 53a, as illustrated in FIG. 1A.

Between registration and transfer, that is, between the transfer nip and the pair of registration rollers 53a or between fusing and transfer, that is, between the fusing nip and the transfer nip, there is a difference in conveyance speed caused by a difference in diameter between rollers or a difference in conveyance speed caused by a difference in alignment. The difference in conveyance speed causes pulling of the paper sheet S between registration and transfer or between fusing and transfer, resulting in generation of a low-quality image. Therefore, the paper sheet S is loosened between registration and transfer or the like or the paper sheet S is loosened between fusing and transfer by controlling a conveyance speed in a fusing unit, and the generation of low-quality image is suppressed.

Incidentally, when an image is formed on a long paper sheet having a length larger than that of A3-size paper, as the length of the long paper sheet is increased, a conveyance length of the paper sheet S increases. Therefore, when there is a difference between a conveyance speed in the transfer nip and a conveyance speed in the pair of registration rollers 53a to suppress the generation of low-quality image caused by a difference in conveyance speed due to a difference in diameter between rollers or a difference in alignment, the loosening of the long paper sheet S1 is increased relative to that of a non-long paper sheet (see FIG. 1A), as illustrated in FIG. 1B.

Therefore, when a rear end of the long paper sheet S1 passes between the pair of registration rollers 53a or the registration rollers 53a are separated from each other during conveyance of the long paper sheet S1, a returning length of the long paper sheet S1 increases as illustrated in FIG. 1C, and a low-quality image caused by shock noise or the like may be generated in the transfer nip.

### SUMMARY

An object of the present invention is to provide an image forming apparatus and a conveyance speed control method which suppress generation of a low-quality image caused by loosening of a paper sheet between a transfer nip and a conveyance member, in the transfer nip.

To achieve the abovementioned object, according to an aspect of the present invention, an image forming apparatus reflecting one aspect of the present invention comprises:

a transferer that forms a transfer nip for transferring an image on a paper sheet;

a conveyance member that is disposed upstream from the transfer nip in a conveyance direction of the paper sheet; and

a hardware processor that increases a conveyance speed of the paper sheet in the conveyance member relative to a conveyance speed of the paper sheet in the transferer and controls conveyance of the paper sheet to loosen the paper sheet between the transfer nip and the conveyance member,

wherein the hardware processor changes a conveyance speed of the paper sheet in the conveyance member in accordance with a conveyance length of the paper sheet in the conveyance member.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1A to FIG. 1C are diagrams illustrating conveyance of paper sheets between a transfer nip and a pair of registration rollers;

FIG. 2 is a schematic diagram illustrating an overall configuration of an image forming apparatus according to the present embodiment;

FIG. 3 is a diagram illustrating a main portion of a control system of the image forming apparatus according to the present embodiment;

FIG. 4 is a diagram illustrating conveyance of a paper sheet between a secondary transfer nip and a pair of registration rollers before changing a conveyance speed;

FIG. 5 is a diagram illustrating conveyance of the paper sheet between the secondary transfer nip and the pair of registration rollers after changing the conveyance speed;

FIG. 6 is a diagram illustrating a looseness detector provided on a guide member; and

FIG. 7 is a flowchart illustrating an example of operation for conveyance speed control in the image forming apparatus.

### DETAILED DESCRIPTION OF EMBODIMENTS

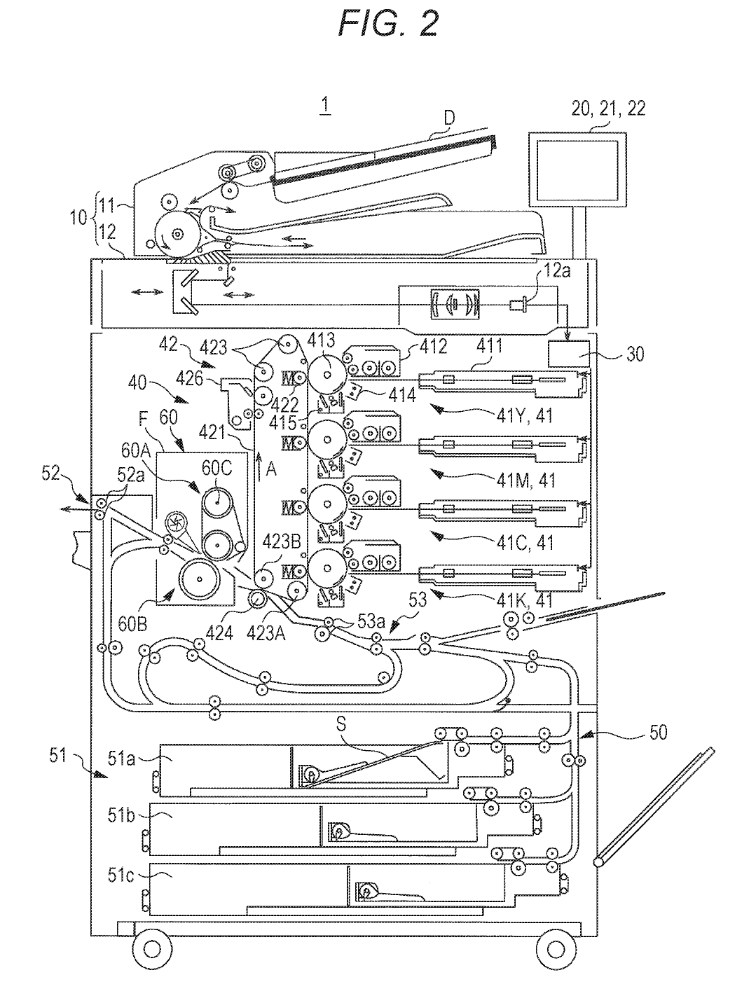

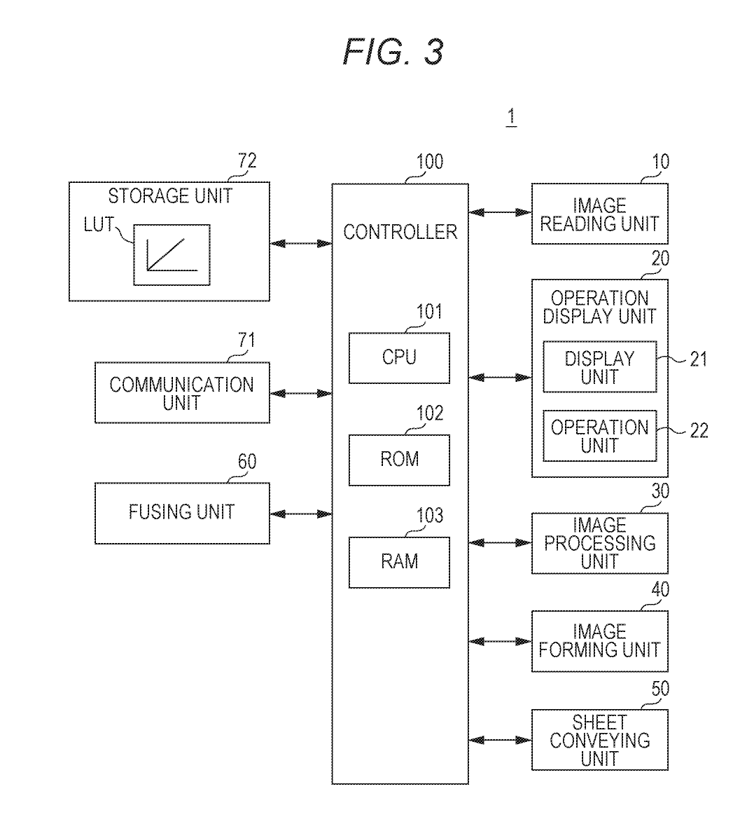

Hereinafter, one or more embodiments of the present invention will be described in detail with reference to the drawings. However, the scope of the invention is not limited to the disclosed embodiments. FIG. 2 is a schematic diagram illustrating an overall configuration of an image forming apparatus 1 according to the present embodiment. FIG. 3 is a diagram illustrating a main portion of a control system of the image forming apparatus 1 according to the present embodiment.

The image forming apparatus 1 according to the present embodiment uses a long paper sheet or a non-long paper sheet as a paper sheet S to form an image on the paper sheet S.

In the present embodiment, the long paper sheet is a sheet having a length in a conveyance direction larger than that of a commonly-used paper sheet of A4-size, A3-size, or the like, and the long paper sheet has a length which cannot be stored in paper feed tray units 51a to 51c in the image forming apparatus. Hereinafter, the words “paper sheet” may include both of a long paper sheet and a non-long paper sheet.

The image forming apparatus 1 is a color image forming apparatus employing an intermediate transfer process in accordance with an electrophotographic process technology. That is, the image forming apparatus 1 primarily transfers toner images of four colors of Y (yellow), M (magenta), C (cyan), K (black) formed on photoreceptor drums 413 to an intermediate transfer belt 421, superposes the toner images of respective colors on the intermediate transfer belt 421, and then secondarily transfers the superposed toner image to a paper sheet to form a toner image.

Furthermore, for the image forming apparatus 1, a tandem system is employed in which the photoreceptor drums 413 corresponding to the four YMCK colors are disposed in series in a running direction of the intermediate transfer belt 421, and the toner images of respective colors are successively transferred to the intermediate transfer belt 421 in a single procedure.

As illustrated in FIG. 3, the image forming apparatus 1 includes an image reading unit 10, an operation display unit 20, an image processing unit 30, an image forming unit 40, a sheet conveying unit 50, a fusing unit 60, a controller 100, and the like.

The controller 100 includes a central processing unit (CPU) 101, a read only memory (ROM) 102, a random access memory (RAM) 103, and the like. The CPU 101 reads a program according to a process content from the ROM 102 and loads the program into the RAM 103, and performs centralized control of blocks of the image forming apparatus 1 in accordance with the loaded program. At this time, various data stored in a storage unit 72 are referred to.

The controller 100 transmits and receives various data, via a communication unit 71, to and from an external device (e.g., personal computer) connected to a communication network, such as a local area network (LAN) or a wide area network (WAN). The controller 100 receives for example image data transmitted from the external device to form a toner image on a paper sheet, on the basis of the image data (input image data).

The image reading unit 10 includes an automatic document feeding device 11 called an auto document feeder (ADF), and a document image scanning device 12 (scanner), and the like.

The automatic document feeding device 11 conveys a document D put in a document tray by using a conveyance mechanism and delivers the document D to the document image scanning device 12. The automatic document feeding device 11 allows continuous collective reading of images (including images on both sides) of a large number of documents D put in the document tray.

The document image scanning device 12 optically scans a document conveyed from the automatic document feeding device 11 onto a contact glass plate, or a document put on the contact glass plate, focuses light reflected from the document on a light receiving surface of a charge coupled device (CCD) sensor 12a, and reads a document image. The image reading unit 10 generates input image data on the basis of a result of reading by the document image scanning device 12. This input image data is subjected to predetermined image processing in the image processing unit 30.

The operation display unit 20 includes, for example, a liquid crystal display (LCD) with a touch panel, and functions as a display unit 21 and an operation unit 22. The display unit 21 displays various operation screens, an image condition, an operation state of each function, or the like, in accordance with a display control signal input from the controller 100. The operation unit 22 includes various operation keys, such as a numeric keypad, a start key, and the like, receives various operations input by a user, and outputs an operation signal to the controller 100.

The image processing unit 30 includes a circuit or the like performing digital image processing on the input image data, in accordance with default setting or user's setting. For example, the image processing unit 30 performs tone correction on the basis of tone correction data (tone correction table LUT) in the storage unit 72, under the control of the controller 100. Furthermore, the image processing unit 30 performs, on the input image data, various correction processing such as color correction or shading correction, compression processing, or the like, in addition to the tone correction. The image forming unit 40 is controlled on the basis of the image data subjected to the processing.

The image forming unit 40 includes image forming units 41Y, 41M, 41C, and 41K, an intermediate transfer unit 42, and the like to form color toner images having a Y component, an M component, a C component, and a K component on the basis of the input image data.

The image forming units 41Y, 41M, 41C, and 41K for the Y component, M component, C component, and K component have a similar configuration. For convenience of illustration and description, common elements are denoted by the same reference signs, and when the common elements are to be distinguished from each other for representation, a letter Y, M, C, or K is added to a corresponding reference sign. In FIG. 2, only elements of the image forming unit 41Y for the Y component are denoted by reference signs, and reference signs for the other image forming units 41M, 41C, and 41K are omitted.

An image forming unit 41 includes an exposure device 411, a developing device 412, the photoreceptor drum 413, a charging device 414, a drum cleaning device 415, and the like.

The photoreceptor drum 413 is a negatively-charged organic photo-conductor (OPC) which is obtained by sequentially stacking an under coat layer (UCL), a charge generation layer (CGL), and a charge transport layer (CTL) on a peripheral surface of, for example, a conductive aluminum cylinder (aluminum tube material).

The controller 100 controls drive current supplied to a drive motor (not illustrated) for rotating the photoreceptor drum 413 to rotate the photoreceptor drum 413 at a constant circumferential speed (linear speed).

The charging device 414 uniformly negatively charges a surface of the photoreceptor drum 413 having photoconductivity. The exposure device 411 includes for example a semiconductor laser, and irradiates the photoreceptor drum 413 with laser light corresponding to an image having each color component. Therefore, the surface of the photoreceptor drum 413 has a potential difference between the surface and the surroundings, and an electrostatic latent image having each color component is formed.

The developing device 412 is, for example, a developing device using a two-component development process, and the developing device 412 applies toner of each color component to the surface of the photoreceptor drum 413 to visualize the electrostatic latent image, and forms a toner image.

The drum cleaning device 415 includes a cleaning member or the like configured to be brought into contact with the surface of the photoreceptor drum 413. The drum cleaning device 415 removes untransferred toner remaining on the surface of the photoreceptor drum 413 by using a cleaning blade, after primary transfer.

The intermediate transfer unit 42 includes the intermediate transfer belt 421, a primary transfer roller 422, a plurality of support rollers 423, a secondary transfer roller 424, a belt cleaning device 426, and the like.

The intermediate transfer belt 421 includes an endless belt and is stretched on the plurality of support rollers 423 into a loop. At least one of the plurality of support rollers 423 includes a driving roller and the other of the plurality of support rollers 423 each include a driven roller. For example, a roller 423A disposed downstream from the primary transfer roller 422 for the K component in a belt running direction preferably includes the driving roller. Thus, the belt can have a constant running speed in a primary transferer. The rotation of the driving roller 423A causes the running of the intermediate transfer belt 421 at a constant speed in a direction indicated by an arrow A.

The primary transfer roller 422 is disposed on an inner peripheral side of the intermediate transfer belt 421 to be opposed to the photoreceptor drum 413 for corresponding color component. The primary transfer roller 422 is brought into pressure-contact with the photoreceptor drum 413 across the intermediate transfer belt 421, and a primary transfer nip is formed to transfer a toner image from the photoreceptor drum 413 to the intermediate transfer belt 421.

The secondary transfer roller 424 is disposed on an outer peripheral side of the intermediate transfer belt 421 to be opposed to a backup roller 423B disposed downstream from the driving roller 423A in the belt running direction. The secondary transfer roller 424 is brought into pressure-contact with the backup roller 423B across the intermediate transfer belt 421, and a secondary transfer nip is formed to transfer a toner image from the intermediate transfer belt 421 to the paper sheet S.

The intermediate transfer belt 421, the backup roller 423B, and the secondary transfer roller 424 correspond to a “transferer” according to the present invention. The secondary transfer nip corresponds to a “transfer nip” according to the present invention.

When the intermediate transfer belt 421 passes through the primary transfer nips, toner images on the photoreceptor drums 413 are primarily transferred sequentially onto the intermediate transfer belt 421. Specifically, primary transfer bias is applied to a primary transfer roller 422 to apply an electrical charge having a polarity opposite to that of the toner to a side of the intermediate transfer belt 421, making contact with the primary transfer roller 422, and a toner image is electrostatically transferred to the intermediate transfer belt 421.

Then, while a paper sheet passes thorough the secondary transfer nip, a toner image on the intermediate transfer belt 421 is secondarily transferred to a paper sheet. Specifically, secondary transfer bias is applied to the secondary transfer roller 424 to apply an electrical charge having a polarity opposite to that of the toner to a side of the paper sheet making contact with the secondary transfer roller 424, and the toner image is electrostatically transferred to the paper sheet. The paper sheet on which the toner image is transferred is conveyed to the fusing unit 60.

The belt cleaning device 426 includes a belt cleaning blade or the like brought into sliding contact with a surface of the intermediate transfer belt 421 to remove untransferred toner remaining on the surface of the intermediate transfer belt 421 after secondary transfer.

The fusing unit 60 includes an upper fusing unit 60A having a fused surface side member disposed on the side of a fused surface of a paper sheet, a lower fusing unit 60B having a back-side supporting member disposed on the side of a surface opposite to the fused surface of the paper sheet, and a heat source 60C, and the like. The pressure-contact of the back-side supporting member with the fused surface side member forms a fusing nip to hold a paper sheet.

In the fusing unit 60, the conveyed paper sheet on which the toner image is secondary transferred is heated and pressed by the fusing nip to fuse the toner image on the paper sheet. The fusing unit 60 is disposed as a unit, in a fuser F.

The sheet conveying unit 50 includes a paper feed unit 51, a paper exit unit 52, a conveyance path unit 53, and the like. The paper feed unit 51 includes three paper feed tray units 51a to 51c configured to store paper sheets S (standard paper, special paper) in accordance with a predetermined kind, in which the paper sheets S are sorted in accordance with the basis weight (stiffness), size, or the like. The conveyance path unit 53 includes a plurality of conveyance rollers such as a pair of registration rollers 53a, and a both-side conveyance path configured to form images on both sides of a paper sheet. The pair of registration rollers 53a corresponds to a “pair of conveyance rollers” according to the present invention.

The pair of registration rollers 53a corrects a position of a paper sheet S in a width direction, under the control of the controller 100. Specifically, when a paper sheet S is held between the pair of registration rollers 53a, the pair of registration rollers 53a moves in the width direction to move the paper sheet S before the front end of the paper sheet enters the secondary transfer nip, and the position of the paper sheet S in the width direction is corrected.

After the pair of registration rollers 53a corrects the position of the paper sheet S in the width direction, the registration rollers 53a are separated from each other before the paper sheet S completely passes between the registration rollers 53a, that is, during conveyance of the paper sheet S, and the registration rollers 53a are returned to positions before movement. Then the registration rollers 53a are pressed against each other again after the rear end of the paper sheet S passes between the pair of registration rollers 53a. Note that the registration rollers 53a may be pressed against each other during the conveyance of the paper sheet S.

Furthermore, a conveyance speed of the paper sheet S between the pair of registration rollers 53a is set faster than a conveyance speed of the paper sheet S between the backup roller 423B and the secondary transfer roller 424, that is, in the secondary transfer nip, under the control of the controller 100. Specifically, the conveyance speed of the paper sheet S between the pair of registration rollers 53a is increased by 0.5% relative to the conveyance speed of the paper sheet S in the secondary transfer nip. Such a configuration loosens the paper sheet S between the secondary transfer nip and the pair of registration rollers 53a (hereinafter, referred to “between registration and transfer).

Between registration and transfer or between the fusing nip and the secondary transfer nip (hereinafter, referred to “between fusing and transfer”), there is a difference in conveyance speed due to a difference in diameter between rollers or a difference in conveyance speed due to a difference in alignment. The difference in conveyance speed causes pulling of the paper sheet S between registration and transfer or between fusing and transfer, resulting in generation of a low-quality image. Therefore, the paper sheet S is loosened between registration and transfer or the paper sheet S is loosened between fusing and transfer by controlling a conveyance speed in a fusing unit 60, and the generation of low-quality image is suppressed.

Furthermore, for the control of the conveyance speed in the fusing unit 60 to generate the loosening of the paper sheet S between fusing and transfer, a detector configured to detect the loosening of the paper sheet S may be provided between fusing and transfer.

The paper sheets S stored in the paper feed tray units 51a to 51c are delivered one by one from an uppermost portion and conveyed to the image forming unit 40 through the conveyance path unit 53. At this time, the pair of registration rollers 53a corrects the inclination of the fed paper sheets S and adjusts conveyance timing.

Then, in the image forming unit 40, the toner images on the intermediate transfer belt 421 are secondarily transferred to one side of the paper sheet S collectively, and a fusing process is performed in the fusing unit 60. The paper sheet S on which an image is formed is discharged outside the image forming apparatus, from the paper exit unit 52 including paper exit rollers 52a.

Incidentally, when an image is formed on a long paper sheet having a length larger than that of A3-size paper, as the length of the long paper sheet is increased, a conveyance length of the paper sheet S increases. Between registration and transfer, since the conveyance length of the paper sheet S in the pair of registration rollers 53a is larger than the conveyance length of the paper sheet S in the secondary transfer nip, as the conveyance length of the paper sheet S is increased, a loosening length of the paper sheet S is increased.

For example, when the conveyance speed of the paper sheet S in the pair of registration rollers 53a is increased by 0.5% relative to the conveyance speed of the paper sheet S in the secondary transfer nip, the conveyance of the paper sheet S having a length of 488 mm in the conveyance direction brings about a maximum loosening length of 2.4 mm. The loosening length represents a length of the paper sheet S between registration and transfer. In contrast, the maximum loosening length of the paper sheet S, having a length of 1,200 mm in the conveyance direction, is 6 mm between registration and transfer, upon conveyance of the paper sheet S.

As described above, when there is a difference between the conveyance speed in the secondary transfer nip and the conveyance speed in the pair of registration rollers 53a to suppress the generation of low-quality image caused by a difference in conveyance speed due to a difference in diameter between rollers or a difference in alignment, the loosening length of the paper sheet S is increased relative to that of the non-long paper sheet, upon forming an image on the long paper sheet.

For example, a difference in loosening length between the long paper sheet having a length of 1,200 mm in the conveyance direction and the non-long paper sheet having a length of 488 mm in the conveyance direction is 3 mm or more, and the loosening length of the long paper sheet is more than twice that of the non-long paper sheet.

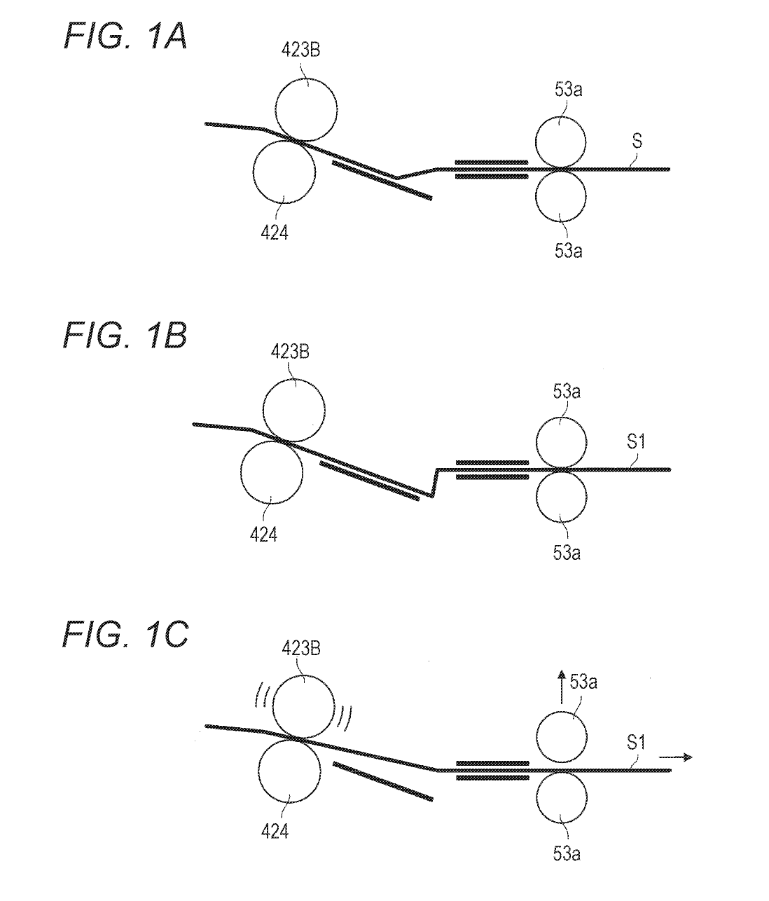

Therefore, when the rear end of the paper sheet S passes between the pair of registration rollers 53a or the registration rollers 53a are separated from each other during conveyance of the paper sheet S, a returning length of the paper sheet S increases as illustrated in FIG. 1C, and a low-quality image caused by shock noise or the like may be generated in the secondary transfer nip.

Therefore, in the present embodiment, the controller 100 controls the conveyance speed of the paper sheet S so that a difference between the conveyance speed of the paper sheet S in the secondary transfer nip and the conveyance speed of the paper sheet S between the pair of registration rollers 53a is reduced depending on the conveyance length of the paper sheet S between the pair of registration rollers 53a. The conveyance length of the paper sheet S represents a length from the front end of the sheet S to a portion of the sheet S positioned between the pair of registration rollers 53a.

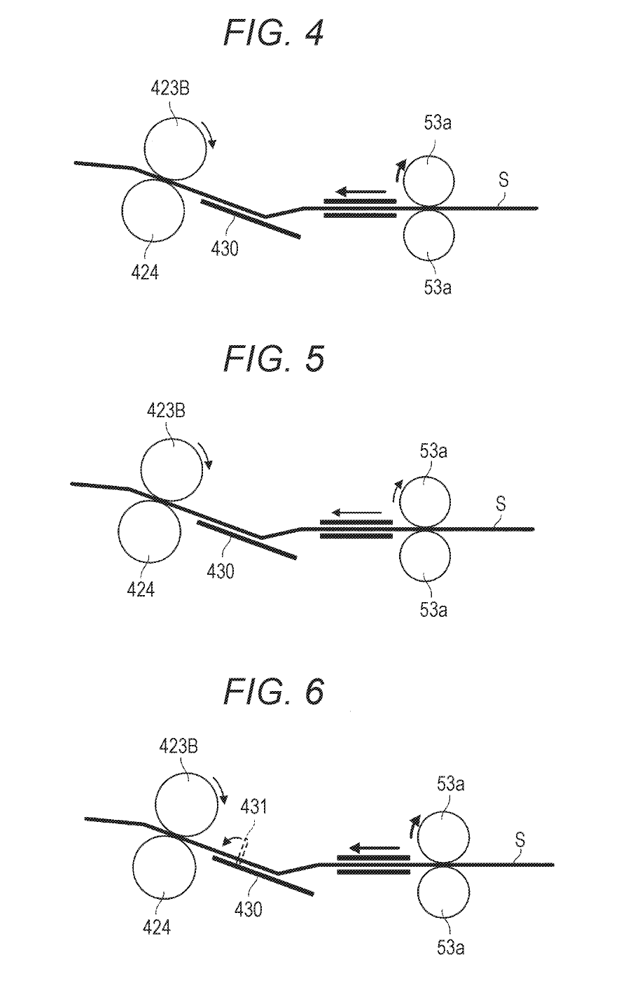

Specifically, as illustrated in FIG. 4, before the conveyance length of the paper sheet S reaches a predetermined length, the controller 100 sets the conveyance speed in the pair of registration rollers 53a to an initial conveyance speed to control the conveyance speed of the paper sheet S.

Then, as illustrated in FIG. 5, after the conveyance length of the paper sheet S reaches the predetermined length, the controller 100 reduces the conveyance speed in the pair of registration rollers 53a to reduce a difference in conveyance speed. The changed conveyance speed of the paper sheet S is set to a conveyance speed equal to, for example, the conveyance speed in the secondary transfer nip.

The predetermined length represents a conveyance length corresponding to, for example, a loosening length of the paper sheet S by which no low-quality image is generated due to the loosening of the paper sheet S, and the predetermined length may be appropriately changed in accordance with a space between registration and transfer in the image forming apparatus 1. For example, when the paper sheet S having a length of 488 mm in the conveyance direction has a loosening length of 2.4 mm by which no low-quality image is generated, the predetermined length corresponds to a conveyance length of 2.4 mm. Note that the predetermined length may be appropriately set in accordance with the kind or the like of the paper sheet S.

Owing to such control as described above, while the loosening of the paper sheet S by which no low-quality image is generated is maintained between registration and transfer, the rest of the long paper sheet can be conveyed. Therefore, an excessive increase of the loosening length of the paper sheet S is suppressed during conveyance of the long paper sheet, and furthermore, the generation of a low-quality image in the secondary transfer nip caused by the loosening of the paper sheet S between registration and transfer can be suppressed.

Incidentally, when the conveyance speed in the pair of registration rollers 53a is equal to the conveyance speed in the secondary transfer nip after the front end of the paper sheet S reaches the position of the pair of registration rollers 53a, the reduction of the conveyance speed in the pair of registration rollers 53a relative to the conveyance speed in the secondary transfer nip may be caused by a difference in conveyance speed due to a difference in diameter between rollers or a difference in alignment.

In this case, since the paper sheet S is pulled toward the secondary transfer nip between registration and transfer, resulting in generation of a low-quality image, the conveyance speed in the pair of registration rollers 53a needs to be prevented from being reduced relative to the conveyance speed in the secondary transfer nip.

In the present embodiment, the conveyance speed in the pair of registration rollers 53a is set faster than the conveyance speed in the secondary transfer nip in the first half of the conveyance of the paper sheet S, and the loosening of the paper sheet S is ensured between registration and transfer. Therefore, even if the conveyance speed in the pair of registration rollers 53a is reduced in the second half of the conveyance of the paper sheet S, an image on the paper sheet S is not adversely affected by the loosening of the paper sheet S.

For example, when the conveyance speed in the pair of registration rollers 53a is increased by 0.5% relative to the conveyance speed in the secondary transfer nip, when the conveyance length of the paper sheet S is 420 mm, the loosening length of the paper sheet S reaches 2 mm. Then, when the conveyance speed in the pair of registration rollers 53a is equal to the conveyance speed in the secondary transfer nip, the paper sheet S can be stably conveyed while ensuring a loosening length of 2 mm.

Furthermore, the changed conveyance speed of the paper sheet S may not be equal to the conveyance speed in the secondary transfer nip. However, in consideration of the suppression of the generation of a low-quality image between registration and transfer, the changed conveyance speed of the paper sheet S is preferably set to a conveyance speed sufficient to prevent the removal of loosening of the paper sheet S between registration and transfer, before the passage of the rear end of the paper sheet S between the pair of registration rollers 53a after the change of the conveyance speed of the paper sheet S, or before the separation of the pair of registration rollers 53a after the change of the conveyance speed of the paper sheet S.

For example, an excessive reduction of the loosening length of the paper sheet S (e.g., less than 0.5 mm) caused by the reduction of the conveyance speed in the pair of registration rollers 53a causes pulling of the paper sheet S between registration and transfer, transfer is thereby influenced by the behavior of the paper sheet S, and further a low-quality image, such as image shift, is generated.

Furthermore, the controller 100 may control the conveyance speed in the pair of registration rollers 53a to be gradually reduced. Such a configuration suppresses an excessive reduction of the loosening of the paper sheet S and gradually reduces an increase in the loosening length of the paper sheet S. Thus, the conveyance speed of the paper sheet S can be controlled moderately in balance.

Furthermore, the controller 100 may perform control of changing the conveyance speed of the paper sheet S a plurality of number of times. For example, the controller 100 may reduce the conveyance speed of the paper sheet S stepwisely. Furthermore, after reducing the conveyance speed of the paper sheet S, the controller 100 may return the reduced conveyance speed of the paper sheet S to the conveyance speed of the paper sheet S before reduction in accordance with the loosening length of the paper sheet S. In this case, the loosening length is, for example, a loosening length having almost no loosening of the paper sheet S between registration and transfer.

When there is no loosening of the paper sheet S, the paper sheet S is pulled between registration and transfer. For such a case, a guide member 430 provided upstream from the secondary transfer nip may be provided with a detector configured to detect a load on the guide member 430. That enables detection of the presence or absence of the loosening of the paper sheet S by using the detector. Then, the controller 100 acquires a result of the detection to return the conveyance speed of the paper sheet S to the conveyance speed of the paper sheet S before change when the loosening of the paper sheet S is excessively reduced, and the loosening of the paper sheet S can be ensured.

Furthermore, in this configuration, as illustrated in FIG. 6, the guide member 430 is desirably provided with a looseness detector 431. When the looseness detector 431 is used as an actuator which is swingable on the guide member 430 in a conveyance direction of the paper sheet S, the angle of the looseness detector 431 relative to the guide member 430 is detected to detect the loosening length of the paper sheet S.

Furthermore, when the guide member 430 is provided with the looseness detector 431, control can be performed not in accordance with a relationship between the conveyance speed in the pair of registration rollers 53a and the conveyance speed in the secondary transfer nip, but in accordance with an actual loosening length of the paper sheet S. That is, a reduced loosening length of the paper sheet S is controlled to be increased, and an increased loosening length of the paper sheet S is controlled to be reduced.

Furthermore, the controller 100 may determine an amount of change in the conveyance speed of the paper sheet S depending on the kind or stiffness of the paper sheet S. For example, when the paper sheet S is cardboard or has large stiffness, since the paper sheet S has strong resilience, the paper sheet S loosened large between registration and transfer has a strong restoring force upon passage of the rear end of the paper sheet S between the pair of registration rollers 53a or upon separation of the pair of registration rollers 53a. Therefore, in such a state, a low-quality image tends to be generated. Therefore, when the paper sheet S being cardboard is employed, the conveyance speed of the paper sheet S is reduced to reduce the conveyance length of the paper sheet S between the pair of registration rollers 53a.

Furthermore, when the paper sheet S employs thin paper or has small stiffness, since the paper sheet S has weak resilience, the paper sheet S loosened large between registration and transfer has a weak restoring force, and a low-quality image is unlikely to be generated. Therefore, when the paper sheet S is thin paper or has small stiffness, an amount of reduction in the conveyance speed of the paper sheet S is reduced.

Furthermore, the controller 100 may determine the amount of change in the conveyance speed of the paper sheet S depending on an environment around the image forming apparatus 1. For example, when humidity is high around the image forming apparatus 1, since the stiffness of the paper sheet S has weak resilience, the amount of reduction in the conveyance speed of the paper sheet S is reduced. Furthermore, when humidity is low around the image forming apparatus 1, since the paper sheet S has strong resilience, the amount of reduction in the conveyance speed of the paper sheet S is increased.

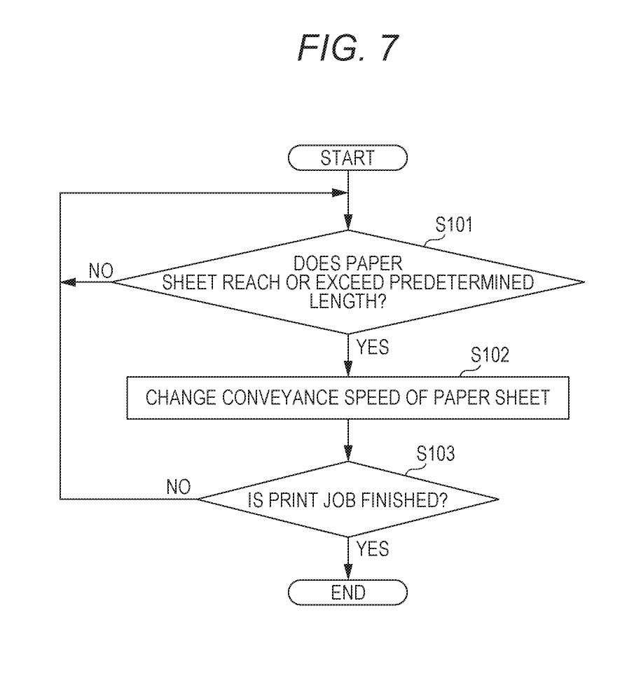

An example of the operation for conveyance speed control in the image forming apparatus 1 configured as described above will be described. FIG. 7 is a flowchart illustrating an example of the operation for conveyance speed control in the image forming apparatus 1. A process of FIG. 7 is appropriately performed in the performance of a print job. Note that the process of FIG. 7 is an example of control performed when the paper sheet S is a long paper sheet.

As illustrated in FIG. 7, the controller 100 determines whether the conveyance length of the paper sheet S reaches or exceeds the predetermined length (step S101). When the conveyance length of the paper sheet S does not reach the predetermined length (step S101, NO), as a result of determination, the process repeats step S101.

In contrast, when the conveyance length of the paper sheet S reaches or exceeds the predetermined length (step S101, YES), the controller 100 changes the conveyance speed of the paper sheet S (step S102). Specifically, the controller 100 reduces the conveyance speed of the paper sheet S between the pair of registration rollers 53a.

Next, the controller 100 determines whether a print job is finished (step S103). When the print job is not finished (step S103, NO) as a result of the determination, the process returns to step S101. In contrast, when the print job is finished (step S103, YES), this control ends.

According to the present embodiment configured as described above, for conveyance of a long paper sheet, an excessive increase of the loosening length of the paper sheet S can be suppressed, and further the generation of a low-quality image in the secondary transfer nip caused by the loosening of the paper sheet S between registration and transfer can be suppressed.

Furthermore, for conveyance of a non-long paper sheet, when shock noise is likely to be generated in the second half of the conveyance of the paper sheet S the conveyance speed in the pair of registration rollers 53a can be reduced during the conveyance, and generation of a low-quality image in the secondary transfer nip can be suppressed.

Note that in the above embodiments, the conveyance speed in the pair of registration rollers 53a is reduced to reduce a difference between the conveyance speed in the secondary transfer nip and the conveyance speed in the pair of registration rollers 53a, but the present invention is not limited to the description. For example, both of the conveyance speed in the secondary transfer nip and the conveyance speed in the pair of registration rollers 53a may be changed to reduce the difference.

In addition, any of the above embodiments is only by way of one specific example to implement the present invention, and is not to be construed as limiting the technical scope of the present invention thereto. In other words, the present invention can be implemented in various forms without departing from the spirit or the main characteristics of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a transferer that forms a transfer nip for transferring an image on a paper sheet;
a conveyance member that is disposed upstream from the transfer nip in a conveyance direction of the paper sheet; and
a hardware processor that increases a conveyance speed of the paper sheet in the conveyance member relative to a conveyance speed of the paper sheet in the transferer and controls conveyance of the paper sheet to loosen the paper sheet between the transfer nip and the conveyance member,
wherein the hardware processor changes a conveyance speed of the paper sheet in the conveyance member in accordance with a conveyance length of the paper sheet in the conveyance member.

2. The image forming apparatus according to claim 1, wherein
the hardware processor changes a conveyance speed of the paper sheet to reduce a difference between a conveyance speed of the paper sheet in the transferer and a conveyance speed of the paper sheet in the conveyance member.

3. The image forming apparatus according to claim 2, wherein
the hardware processor reduces a conveyance speed of the paper sheet in the conveyance member to reduce the difference.

4. The image forming apparatus according to claim 1, wherein
when a conveyance length of the paper sheet reaches a conveyance length corresponding to a loosening length of the paper sheet by which no low-quality image is generated due to the loosening of the paper sheet, the hardware processor changes a conveyance speed of the paper sheet.

5. The image forming apparatus according to claim 1, wherein
the hardware processor changes a conveyance speed of the paper sheet to prevent the removal of loosening of the paper sheet between the transfer nip and the conveyance member before passage of a rear end of the paper sheet through the conveyance member after the change of the conveyance speed of the paper sheet.

6. The image forming apparatus according to claim 1, wherein
the hardware processor
controls the conveyance member to separate the conveyance member during conveyance of the paper sheet, and
changes a conveyance speed of the paper sheet to prevent removal of loosening of the paper sheet between the transfer nip and the conveyance member before separation of the conveyance member after change of a conveyance speed of the paper sheet.

7. The image forming apparatus according to claim 1, wherein
the hardware processor performs control of changing a conveyance speed of the paper sheet a plurality of number of times.

8. The image forming apparatus according to claim 7, wherein
after change of a conveyance speed of the paper sheet, the hardware processor returns the changed conveyance speed of the paper sheet to a conveyance speed of the paper sheet before change in accordance with a loosening length of the paper sheet.

9. The image forming apparatus according to claim 1, further comprising
a looseness detector that detects loosening of the paper sheet,
wherein the hardware processor changes a conveyance speed of the paper sheet on the basis of a result of the detection performed by the looseness detector.

10. The image forming apparatus according to claim 1, wherein
the hardware processor determines an amount of change in conveyance speed of the paper sheet, depending on a kind of the paper sheet.

11. The image forming apparatus according to claim 1, wherein
the hardware processor determines an amount of change in conveyance speed of the paper sheet depending on the stiffness of the paper sheet.

12. The image forming apparatus according to claim 1, wherein
the hardware processor determines an amount of change in conveyance speed of the paper sheet depending on an environment around the image forming apparatus.

13. A conveyance speed control method for an image forming apparatus, the apparatus including:
a transferer that forms a transfer nip for transferring an image on a paper sheet; and
a conveyance member that is disposed upstream from the transfer nip in a conveyance direction of the paper sheet,
the method comprising:
increasing a conveyance speed of the paper sheet in the conveyance member relative to a conveyance speed of the paper sheet in the transferer, and controlling conveyance of the paper sheet to loosen the paper sheet between the transfer nip and the conveyance member; and
changing a conveyance speed of the paper sheet in the conveyance member in accordance with a conveyance length of the paper sheet in the conveyance member.
